(19) United States
(12) Patent Application Publication
(10) Pub. No.: US 2006/0016769 A1
(43) Pub. Date: Jan. 26, 2006

(54) Filter assembly and methods

(76) Inventors: John R. Hacker, Edina, MN (US); Brent A. Gulsvig, Fairbault, MN (US)

Correspondence Address: MERCHANT & GOULD PC, P.O. BOX 2903, MINNEAPOLIS, MN, 55402-0903, US

(21) Appl. No.: 11/189,445

(22) Filed: Jul. 26, 2005

Related U.S. Application Data
(63) Continuation-in-part of application No. PCT/US04/02071, filed on Jan. 27, 2004.
(60) Provisional application No. 60/443,303, filed on Jan. 28, 2003.

(51) Int. Cl. B01D 35/30

(52) U.S. Cl. 210/791; 210/232; 210/171

(57) ABSTRACT

A filter assembly has a protected opening and trapped contaminant to reduce the chance of fluid dripping on the ground or on a person performing servicing. Servicing can be performed without the use of tools. A filter assembly includes a base, a bowl, and a filter cartridge with an impermeable outer jacket. A locking cap engages the filter base to manipulate a clamp arrangement. The clamp arrangement selectively secures and releases the filter base together to the bowl.

This application is a continuation-in-part application of international application No. PCT/US2004/002071 filed Jan. 27, 2004; international application No. PCT/US2004/002071 claims priority to U.S. provisional patent application 60/443,303, filed Jan. 28, 2003. Both of the disclosures of PCT/US2004/002071 and U.S. provisional 60/443,303 are incorporated herein by reference in their entirety.

### TECHNICAL FIELD

This disclosure relates to fluid filters for use in hydraulic systems, lube systems, and fuel systems. In particular examples, this disclosure concerns apparatus and methods for allowing the servicing of a filter and controlling spillage, and in some applications, without requiring the use of tools.

### BACKGROUND

Filters are commonly used in connection with lubrication systems and fuel systems for internal combustion engines, and hydraulic systems for heavy duty equipment. Filters are also used in many other types of fluid systems, for example, a variety of industrial filtration applications. In these types of systems, the filter is changed periodically. In the art, there are at least two standard types of filters used. One is a spin-on canister filter, while the other is a bowl-cartridge filter.

Spin-on canister filters are disposable units, which typically include a single-use housing holding a permanently mounted, non-replaceable filter element (cartridge filter). The canister holding the cartridge filter is usually spun onto a filter head, by threaded engagement. The liquid to be cleaned passes from the filter head and into the housing for filtering. The cleaned liquid exits the housing and re-enters the filter head. After some period of use, the spin-on canister filter is removed from the filter head and is discarded. A new spin-on canister filter is then mounted onto the filter head.

Bowl-cartridge filters, on the other hand, typically include a re-useable bowl holding a replaceable filter element (cartridge filter). Bowl-cartridge filters are sometimes preferred or required to be used instead of spin-on canister filters due to disposal or other issues. Bowl-cartridge filters are also mounted onto a filter head (also called a filter base), wherein liquid to be cleaned passes through the filter head, into the bowl, through the replaceable cartridge filter, outside of the bowl, and back into the filter head. After a period of use, the bowl-cartridge filter is removed from the filter head, the replaceable cartridge filter is removed from the re-useable bowl. The old cartridge filter is discarded, and replaced with a new cartridge filter. The new cartridge filter is operably mounted into the re-useable bowl, to provide a refurbished bowl-cartridge filter. This refurbished bowl-cartridge filter, containing the new cartridge filter, is then mounted onto the filter head.

Some of the benefits of a spin-on filter include that the opening is protected and the fluid contained therein is trapped. This prevents the fluid within the filter from spilling, or dripping on the ground, or getting on the person that is servicing the filter. In many cases, however, the spin-on cartridge filter is not incineratable.

With bowl-cartridge filters, on the other hand, the cartridge is easily incineratable. The cartridge filter within the bowl-cartridge typically contains minimal material to throw away and no material to recycle. In some instances, however, bowl-cartridge filters have a disadvantage in that while servicing, the contaminated fluid is exposed in the bowl and can drip to the ground or onto the person performing the servicing.

These different type of filter systems present problems. Improvements are desirable.

### SUMMARY OF THE DISCLOSURE

A filter assembly and methods are provided that combine the benefits of a spin-on cartridge filter with the benefits of a bowl-cartridge filter. Some example results include a filter assembly having a protected opening and trapped contaminant, to reduce the chance of fluid dripping on the ground or on the person performing the servicing, and a disposable cartridge. In certain example filter assemblies and methods, there are additional benefits of being able to perform servicing quickly, cleanly, and without the use of any tools.

A filter assembly is provided. In some described examples, the filter assembly has a filter base, a bowl removably attached to the base, and a filter cartridge with filter media removably positioned within the bowl. Examples described include the filter cartridge having an impermeable outer jacket around a region of filter media. The outer jacket helps to prevent contaminated fluid from spilling during servicing.

Some described examples include a locking cap to selectively engage the filter base. A clamp arrangement is described as being operable to selectively secure and release the filter base together to the bowl by engagement between the locking cap and the filter base.

Methods of assembling, filtering, and servicing are provided. Described methods will use the types of filter assemblies characterized above.

A method of servicing, without the use of tools, is provided. The described method includes releasing a clamp arrangement, by hand and without the use of tools, from engagement with the filter base and the bowl. The bowl and filter cartridge are removed from the filter base. A second filter cartridge is provided within the bowl. The bowl having the second filter cartridge is mounted on the filter base. A clamp arrangement is engaged to operably secure the filter base and the bowl having the second filter cartridge.

### BRIEF DESCRIPTION OF THE DRAWINGS

FIG. 1 is a top perspective view of one embodiment of a filter assembly, constructed according to principles of this disclosure;

FIG. 2 is a bottom perspective view of the filter assembly depicted in FIG. 1;

FIG. 3 is a top, exploded, perspective view of the bowl-cartridge filter depicted in FIGS. 1 and 2;

FIG. 4 is a top, exploded, perspective view of the filter base and locking cap depicted in FIGS. 1 and 2, and useable with the bowl-cartridge filter of FIG. 3;

FIG. 5 is a bottom, exploded, perspective view of the bowl-cartridge filter depicted in FIGS. 3;

FIG. 6 is a bottom, exploded, perspective view of the filter base and locking cap depicted in FIG. 4, and useable with the bowl-cartridge filter of FIGS. 3 and 5;

FIG. 7 is an enlarged, top perspective view of a portion of the filter assembly of FIGS. 1 and 2;

FIG. 8 is a schematic, cross-sectional view of the filter assembly of FIGS. 1 and 2;

FIG. 9 is a bottom, perspective view of one embodiment of the locking cap used in the filter assembly depicted in FIGS. 1-8; and

FIG. 10 is a schematic depiction of a piece of equipment having an engine utilizing filter assemblies depicted in FIGS. 1 and 2.

### DETAILED DESCRIPTION

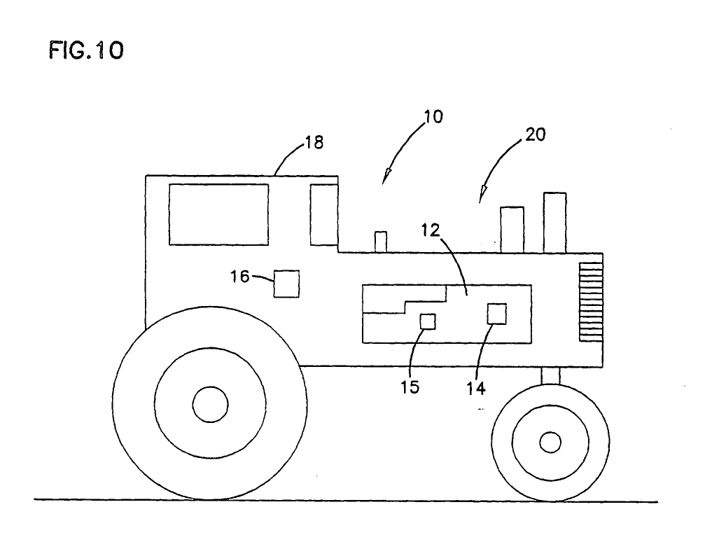

First, attention is directed to FIG. 10. FIG. 10 is a schematic depiction of equipment 10 including an engine 12. The equipment 10 includes a lubrication system 14, a fuel system 15, and a hydraulic system 16. The lubrication system 14, the fuel system 15, and the hydraulic system 16 will need to have a fluid in the system (oil, fuel, or hydraulic fluid) cleaned. To provide the cleaning function, a fluid filter assembly is utilized. In the example embodiment shown in FIG. 10, there are three fluid filter assemblies 20 shown, one for the lubrication system 14, one for the fuel system 15, and one for the hydraulic system 16. Equipment 10 shown in FIG. 10 is a tractor 18. The fluid filter assembly 20 is useable with other types of equipment including bulldozers, skid steers, payloaders, mining equipment, over-the-highway trucks, off-road trucks, combines, and other types of equipment, including industrial filtration, generators, and any system with an engine or hydraulic system.

For the systems described herein, mobile hydraulic filters will have operating pressures generally between −7 psi and 700 psi. Operating pressures for an engine lube system will be 40 psi-80 psi, with compressor lube systems being about 250 psi. For fuel systems, if the pressure is on the upstream side of the pump, it will be under vacuum pressure of about -10 psi. If used as a secondary filter, on the downstream side of the pump, the operating pressures will be 60 psi. In industrial hydraulic applications, the pressures are generally high, such as up to 6,000 psi. Of course, the pressures can vary, and these are simply examples.

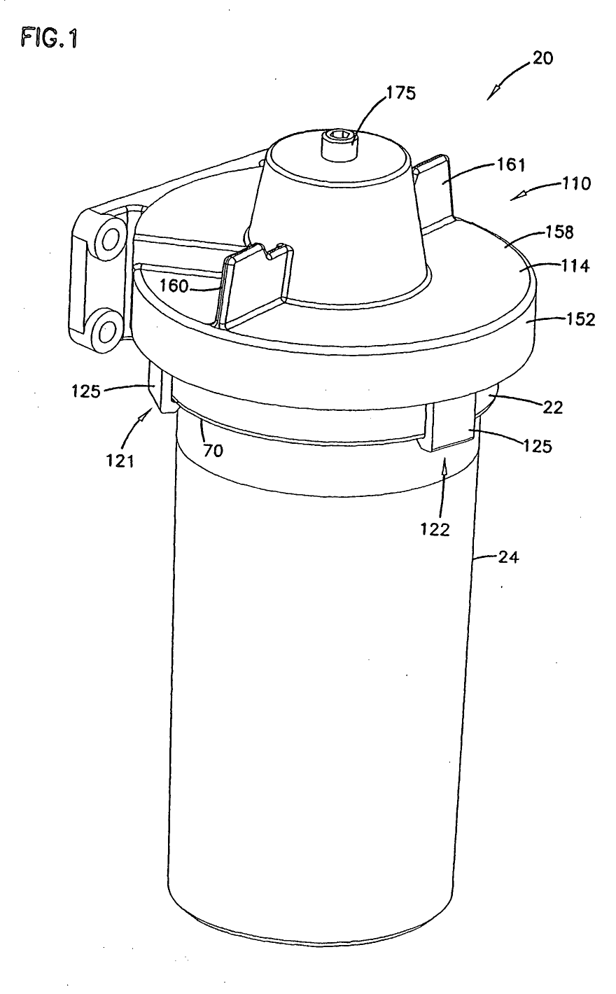

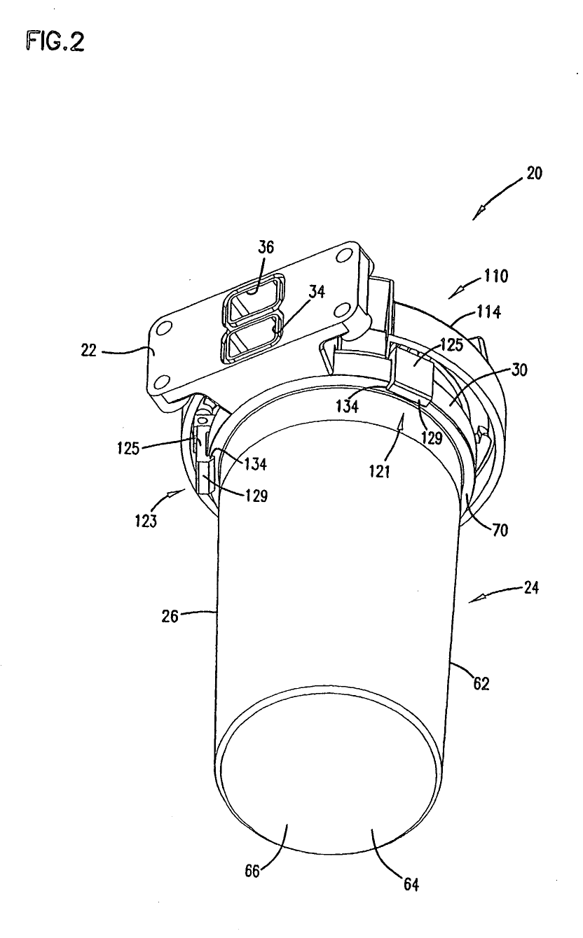

Attention is now directed to FIGS. 1 and 2. One embodiment of the fluid filter assembly 20 is illustrated in perspective view. The fluid filter assembly 20 depicted includes a filter base 22 (also, sometimes referred to as a “filter head”) and a bowl-cartridge filter 24. The filter base 22 is typically positioned in fluid systems (such as lube systems 14, fuel systems, or hydraulic systems 16) such that fluid is directed from the system by the filter base 22 and through the bowl-cartridge filter 24.

By the term “bowl-cartridge filter”, it is meant a filter having a re-useable housing or bowl holding a replaceable cartridge filter (filter element). After a period of use, when the cartridge filter becomes clogged or restriction increases to an unacceptable level, the bowl-cartridge filter is serviced. By “serviced” or variants thereof, it is meant that the bowl-cartridge filter is removed from the filter base, the cartridge filter is removed from the bowl, and a new cartridge filter is installed within the bowl. The bowl with the new cartridge filter is then mounted onto the filter base.

The filter base 22 is constructed for operable receipt or mounting of the bowl-cartridge filter 24. By “operable receipt or mounting” and variants thereof, it is meant that the filter base 22 includes appropriate structure for engaging the bowl-cartridge filter 24, such that fluid to be cleaned is directed through the appropriate channels and is cleaned as intended.

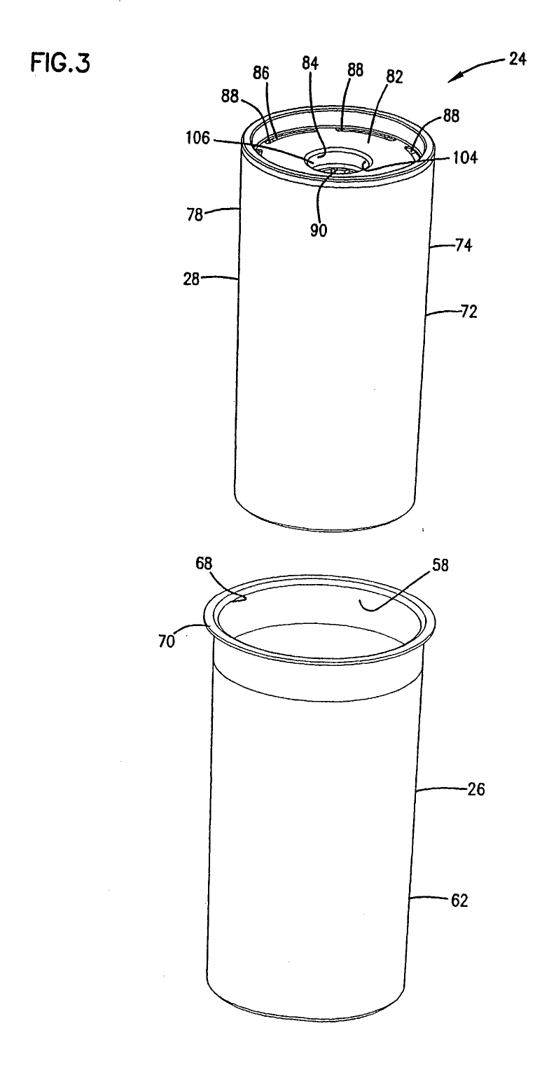

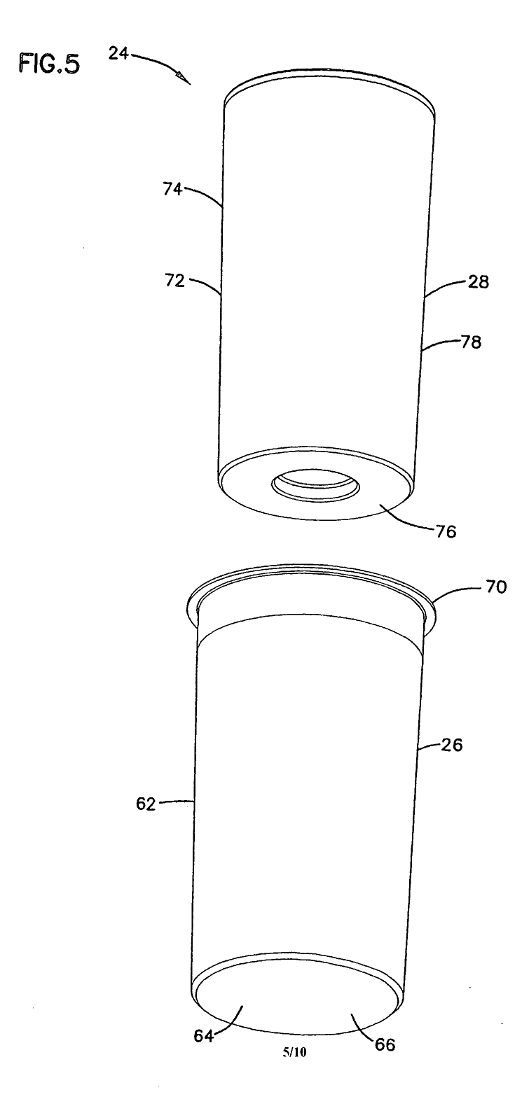

In reference to FIGS. 3 and 5, it can be seen how the bowl-cartridge filter 24 has a reuseable housing or bowl 26 operably holding a removable and replaceable cartridge filter 28.

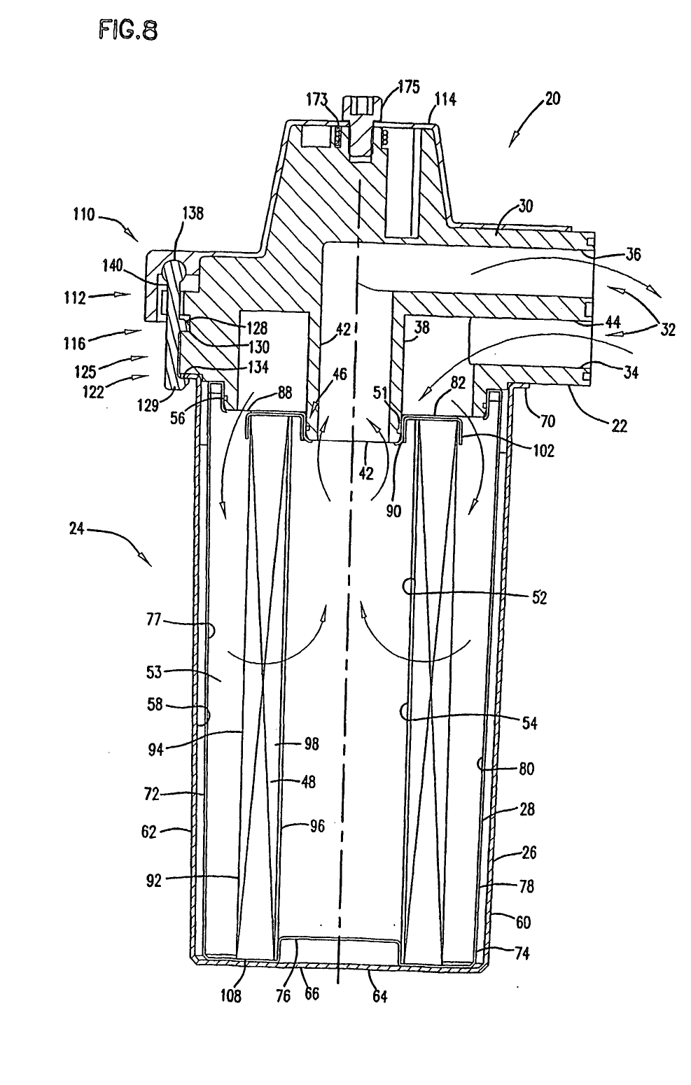

In FIG. 8, there is a cross-sectional view of the filter assembly 20. The view in FIG. 8 depicts the bowl-cartridge filter 24 operably mounted to the filter base 22. The filter base 22 includes a block 30 defining channels 32 in order to allow for the inflow and outflow of fluid to be directed into the bowl-cartridge filter 24. The filter block 30 defines an inlet port 34, an outlet port 36, and an interior or center tube or spud 38. The center spud 38 is circumscribed by the outer wall 40 of the block 30. The spud 38 defines an outflow channel 42 that begins in the interior of the bowl-cartridge filter 24 and ends at the outlet port 36. The inlet port 34 is in fluid flow communication with inlet channel 44. Inlet channel 44 is depicted in FIG. 8 as at least partially surrounding the spud 38.

A seal arrangement 46 helps to contain fluid from bypassing a region of filter media 48 within the cartridge filter 28. In the embodiment shown, the seal arrangement 46 includes a seal member 50 located between the spud 38 and a portion of the cartridge filter 28. Seal member 50 prevents fluid from passing from the inlet channel 44 into a cleaned fluid volume 52 and into the outflow channel 42, without passing through the filter media 48 first. In the embodiment shown, the filter media 48 is a tubular construction, for example shown in FIG. 8 as cylindrical, defining a central open volume 54. The central open volume 54 corresponds to the cleaned fluid volume 52, because the fluid that is within the central open volume 54 could not have gotten to that location without first passing through the filter media 48.

A second seal member 56 is positioned between the filter base 22 and the cartridge filter 28 in order to prevent the passage of fluid from the inlet channel 44 into an interior volume 58 of the bowl 26.

The housing or bowl 26 is depicted as a thin wall construction 60 defining interior volume 58. The bowl 26 can also be a thick walled construction, especially if used in hydraulic applications. The wall 60 has a continuous exterior side wall 62 and a bottom end wall 64 forming a closed end 66. At an end opposite to the closed end, the bowl 26 defines a mouth or opening 68 (FIG. 3) for receipt of the cartridge filter 28. In preferred constructions, the bowl 26 further includes a ledge or lip 70 circumscribing the opening 68. The lip 70 projects radially relative to the side wall 62. In the embodiment shown in FIG. 8, the radial projection of the lip 70 is an outwardly radial projection. One of the purposes of the lip 70 is discussed further below in connection with a clamp arrangement.

The bowl 26 operably holds the removable and replaceable cartridge filter 28 within the interior 58. The cartridge filter 28 is removable and replaceable from the bowl 26, when the bowl 26 is removed from the filter base 22, leaving the open mouth 68 of the bowl 26. The cartridge filter 28 can be removed and replaced through the mouth or opening 68.

The cartridge filter 28 preferably includes a protective jacket 72. The jacket 72 will typically be constructed of an impermeable material such that fluid flowing into and out of the cartridge filter 28 cannot pass through the jacket 72. One of the purposes of the jacket 72 is to contain the contaminated fluid within the cartridge filter 28 when servicing. The jacket 72 allows for the removal of the cartridge filter 28 from the bowl 26 and the disposal of the cartridge filter 28 without dripping or spilling on the ground or on the person doing the servicing. In certain implementations, the jacket 72 includes a continuous outer side wall 74 and a closed bottom wall 76. In the embodiment shown, the jacket 72 forms a generally cylindrical container 78 defining an interior 80. At the end opposite to the bottom wall 76, there is a baffle plate 82. In FIG. 3, it can be seen that the baffle plate 82 defines a central, fluid flow outlet 84 and an inlet arrangement 86. The inlet arrangement 86 allows for fluid to be filtered to enter into the cartridge filter 28 from the filter base 22. The fluid flow outlet 84 permits the passage of filtered fluid from the cartridge filter 28 into the filter base 22.

In the embodiment shown, the inlet arrangement 86 is illustrated in FIG. 3 as a plurality of slotted apertures 88 in the baffle plate 82. The slotted apertures 88 circumscribe the fluid flow outlet 84. The fluid flow outlet 84, in the embodiment shown, is illustrated as a central aperture 90 in the baffle plate 82. As such, in the illustrated embodiment, the inlet arrangement 86 and fluid flow outlet 84 are arranged in a coaxial relationship. By “coaxial”, it is meant that the central axis of the central aperture 90 is the same as the central axis formed by the circle that would join all of the slotted apertures 88. Other inlet arrangements and outlet arrangements are useable. The one illustrated is an example only.

The jacket 72 can be constructed from many different types of materials. Preferably, the jacket 72 will be an impermeable material. In preferred applications, the jacket 72 will also be made of a material that is easily disposable, such as by incineration. One type of material that can be used for the jacket 72 is plastic.

Located within the interior 80 of the jacket 72 is the filter media 48. In preferred implementations, the filter media 48 is formed in a tube, to define the cleaned fluid volume 52. In the embodiment shown, the filter media 48 is shown to be a cylindrical filter pack 92. The filter pack 92 has an upstream side 94 that is in communication with an unfiltered fluid volume 53. The filter pack 92 has a downstream side 96 that is in fluid communication with the cleaned fluid volume 52. In preferred applications, the filter pack 92 is a pleated construction 98. The pleated construction 98 can be cellulose media, synthetic media, or blends thereof.

The filter pack 92, in the embodiment shown, has an end cap 102. The filter pack 92 is bonded or in other ways secured to the end cap 102 in order to ensure that fluid cannot get from the unfiltered fluid volume 53 to the cleaned fluid volume 52 without passing through the filter media 48.

In the embodiment shown, the baffle plate 82 has a sealing engagement surface 104 (FIG. 3). The sealing engagement surface 104 is illustrated as an internal radial surface 106 (FIG. 3) that is directed toward the cleaned fluid volume 52. In FIG. 8, it can be seen how the spud 38 engages the sealing engagement surface 104 and forms a seal 51 between the seal member 50 and the radial surface 106.

At an end 108 of the media pack 92, opposite of the end cap 102, the media pack 92 is secured to the jacket 72 in a sealing engagement. This can be through the use of potting material or other forms of bonding, including directly bonding to the jacket 72.

In reference to FIG. 8, it should now be apparent how fluid flows through the cartridge filter 28. Fluid to be cleaned flows through the filter base 22 by entering the inlet port 34. The fluid goes into the inlet channel 44 and then passes through the slotted apertures 88 in the inlet arrangement 86 (FIG. 3) of the cartridge filter 28. The fluid to be cleaned then flows into the unfiltered fluid volume 53. The unfiltered fluid volume 53 is the volume between the inner surface 77 of the side wall 74 of the jacket 72 and the upstream side 94 of the filter media 48. The fluid then passes through the filter media 48 and through the downstream side 96 into the cleaned fluid volume 52. The filter media 48 removes contaminant and debris from the fluid. From the cleaned fluid volume 52, the fluid then passes through the outflow channel 42 formed by the spud 38. This is also within the fluid flow outlet 84 (FIG. 3), which is circumscribing and in sealing engagement with the spud 38. From the outflow channel 42, the fluid then flows through the outlet port 36 for use by downstream equipment 10.

In preferred embodiments, there is a snug or tight fit between the filter cartridge 28 and the bowl 26. By the term “snug” or “tight” fit, it is meant a fit between the cartridge 28 and the bowl 26 that is sufficiently close to result in any loads on the cartridge 28 to be transferred to the bowl 26. As such, there is a “load-transferring fit” between the cartridge 28 and the bowl 26. The load-transferring fit between the cartridge 28 and the bowl 26 can mean that the jacket 72 can be constructed of inexpensive materials, including materials that do not need to be able to withstand force. In some example arrangements, the clearance between the outer wall of the jacket 72 and the inner wall of the bowl 26 can be a line-to-line fit, and will be at most 0.5 mm, typically not more than 0.3 mm.

In accordance with principles of this disclosure, the filter assembly 20 further includes, in some implementations, a system 110 to allow for the servicing of the filter assembly 20 by hand and without the use of additional external tools. By the use of the term “without the use of tools” and variants thereof, it is meant that tools that are typically used to service filters, such as wrenches or other types of hand or power tools that are used to apply torque, are not needed in order to release the filter base 22 from the bowl-cartridge filter 24. While certain external tools may be used for convenience to assist, the main force used to release the filter base 22 from the bowl-cartridge filter 24 can be done by hand and without needing the assistance of hand tools or power tools.

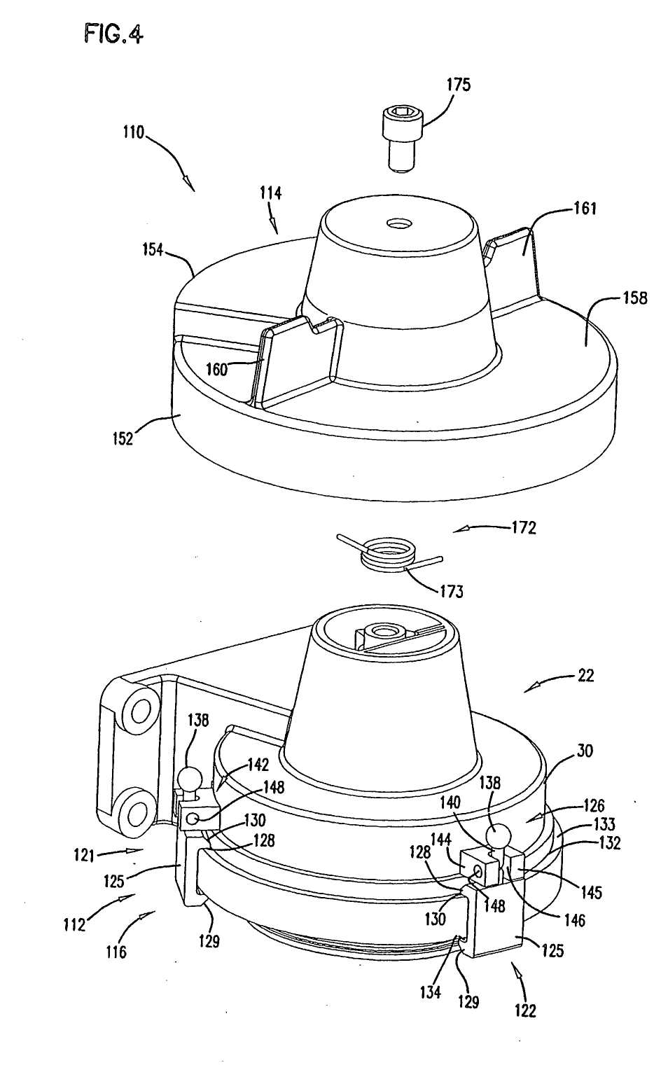

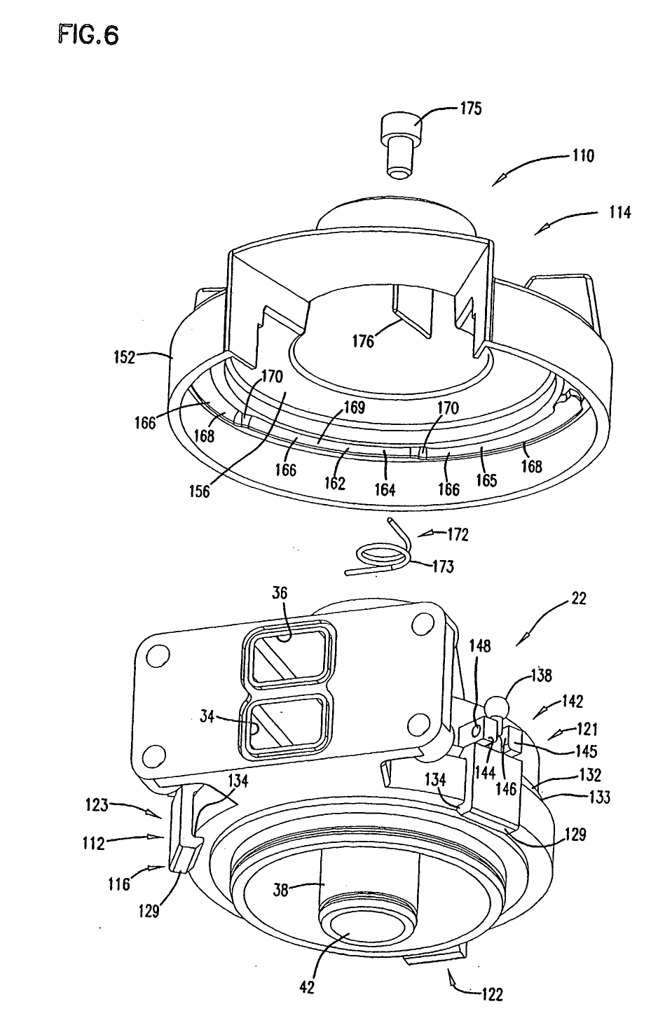

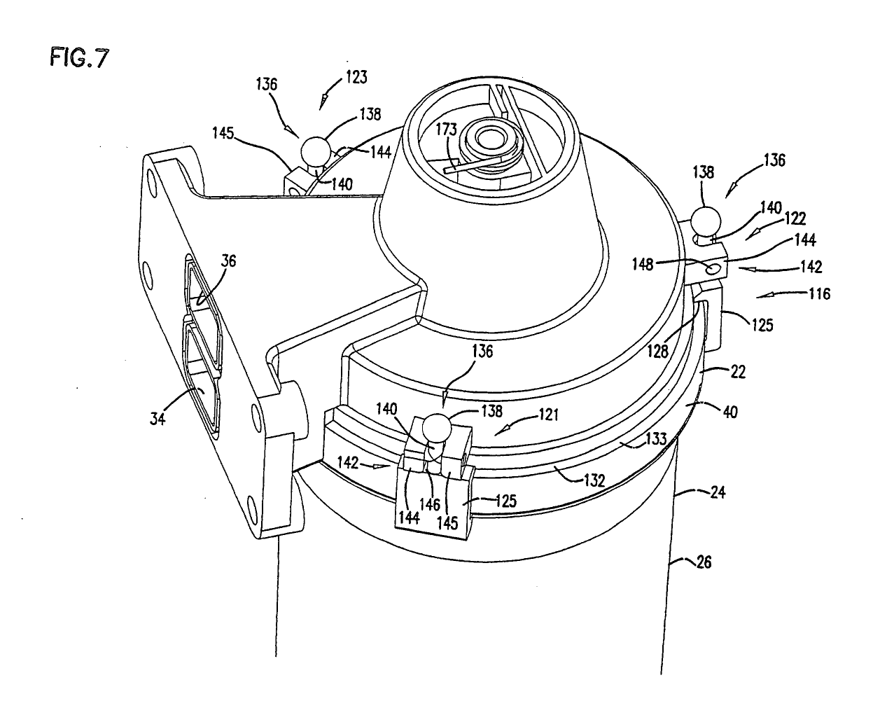

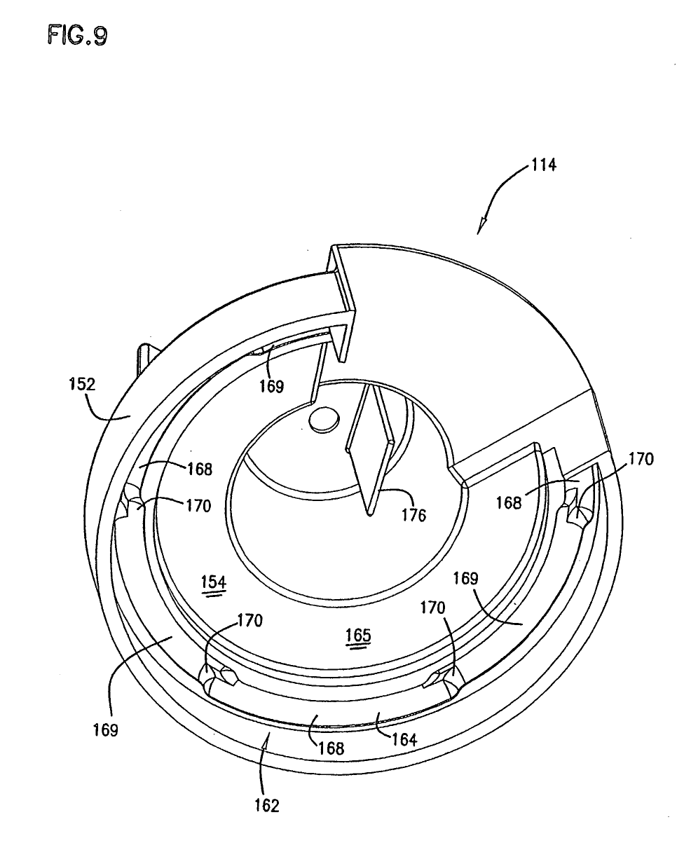

In the illustrated implementation of the system 110, there is a clamp arrangement 112. The clamp arrangement 112 is operable to selectively secure and release the filter base 22 together to the bowl 26. One way this is done is by engagement between a cap 114 and the filter base 22. The cap 114 is also referred to herein as a “locking” cap, but it should be understood that the cap 114 is used for functions of both locking the filter base 22 to the bowl 26 as well as releasing or unlocking the filter base 22 to the bowl 26. FIGS. 1 and 8 show the cap 114 operably mounted on the filter base 22. FIGS. 4 and 6 show exploded, perspective views of the cap 114 and the filter base 22. FIG. 9 shows a bottom view of one illustrated embodiment of the locking cap 114. FIG. 7 shows the filter base 22 before the locking cap 114 is mounted thereon.

In general, the clamp arrangement includes a hook arrangement 116. One type of hook arrangement 116 is useable to be moveable into and out of engagement with the filter base 22 and the bowl 26. As such, one type of hook arrangement 116 includes hooking structure that engages, secures, or otherwise connects the filter base 22 to the bowl 26. By the term “moveable into and out of engagement”, it is meant any type of movement that will selectively and releasably secure the bowl 26 and the filter base 22 together. Certain preferred embodiments described herein will provide further definition about example, preferred directions of moveable engagement. In general, the locking cap 114 is moved relative to the filter base 22, causing the hook arrangement 116 to move either into secure engagement or out of secured engagement between the base 22 and the bowl 26.

In the embodiment shown, the clamp arrangement includes a plurality of discrete clamps. The particular embodiment shown has three clamps 121, 122, and 123. In the embodiment shown, each of the first clamp 121, second clamp 122, and third clamp 123 is constructed identically to the other. The structure of the clamps 121, 122, and 123 will be provided with common reference numerals to depict its common structure. Each of the clamps 121, 122, 123 has a respective clamp member 125. Each clamp member 125 is arranged relative to a remaining portion 126 (FIG. 4) of the clamp arrangement 112 to be moved into and out of engagement between the bowl 26 and the filter base 22. In the embodiment shown, each clamp member 125 has a first hook 128 and a second hook 129. In the embodiment shown, each of the first hooks 128 is selectively moveable into and out of secured engagement with the filter base 22. In particular, each of the first hooks 128 has a catch 130 that is moved into and out of engagement in a recess 132 defined by the filter base 22. The recess 132 in the filter base 22 can be seen as a generally circumferential surface extending along a substantial amount of the outer periphery of the filter base 22. The parts of the filter base 133 adjacent to the recess 132 bear much of the axial load between the bowl 26 and the base 22 when the base 22 and the bowl 26 are secured together and the filter assembly 20 is in operation.

Each of the second hooks 129 has a catch 134 that is moved into and out of secured engagement with the bowl 26. In the embodiment shown, each catch 134 is moved into and out of engagement with the lip 70 on the bowl 26.

In the illustrated embodiment, each of the clamps 121, 122, 123 includes a cap engagement member 136 (FIG. 7). The cap engagement member 136 interacts with the cap 114 to enable the selective securing and releasing of the base 22 and the bowl 26. As illustrated, each cap engagement member 136 is shaped to smoothly interact or engage with respective corresponding structure on the cap 114. In the embodiment shown, the cap engagement member 136 is rounded to form a ball 138. How the ball 138 interacts with the cap 114 is described further below.

In the illustrated embodiment, each of the clamps 121, 122, 123 has a first shaft 140 in extension from the cap engagement member 136. Extending from the first shaft 140 is the clamp member 125. Thus, it can be appreciated that movement on the cap engagement member 136 translates to the clamp member 125 through the shaft 140.

Further, in the particular embodiment illustrated, there is a clamp mount 142 for each respective clamp 121, 122, 123. Each clamp mount 142 has a pair of upstanding walls 144, 145 with a recess 146 therebetween. The recess 146 is to permit passage of the first shaft 140 within it. In the embodiment shown, the upstanding walls 144, 145 pivotally support a second shaft 148 therein. As such, the second shaft 148 extends between and is pivotally mounted within the walls 144, 145. The second shaft 148, in the illustrated embodiment, is perpendicular to the first shaft 140. The second shaft 148 cooperates with the walls 144, 145 of the clamp mount 142 to allow for a pivot mount 150 for each respective clamp 121, 122, 123.

Turning now to FIGS. 6, 9, and 10, the illustrated embodiment of the locking cap 114 is described. The locking cap 114, in the embodiment shown, includes a surrounding rim 152 and an end wall surface 154. The wall surface 154 has a filter base side 156 and a hand-manipulation side 158 (FIG. 4). The hand-manipulation side 158 is the portion of the wall surface 154 that is opposite to the bowl-cartridge filter 124. The hand-manipulation side 158 is the portion that would be handled and manipulated by a person performing servicing of the filter assembly 20. In the embodiment shown in FIG. 4, the hand-manipulation side 158 includes a pair of flange grasping members 160, 161 that are sized to allow for grasping by a human hand to permit manipulation of the cap 114. In particular, the flange grasping members 160, 161 are sized to allow for a person to grasp and apply rotational motion, or torque, to the locking cap 114 relative to the filter base 22.

On the filter base side 156, the locking cap 114 defines a clamp engagement track 162. The clamp engagement track engages each of the balls 138 of the cap engagement member 136 of each of the clamps 121, 122, 123 to cause pivoting of each respective clamp about each of their respective pivot mounts 150.

In the embodiment shown, the clamp engagement track 162 is a continuous track 164 defined by the inside axial portion 165 of the wall surface 154. By the term “continuous”, it is meant that there are no disruptions in the track 164, although the shape of the track may change. Specifically, in the embodiment shown, the continuous track 164 defines a plurality of segments 166.

In the embodiment shown, there is a first group of segments 168 and a second group of segments 169. The first group of segments 168 is spaced a first distance from a center point of the locking cap 114. The second group of segments 169 is spaced a second distance from the center point of the locking cap 114. The first distance is greater than the second distance. Between the first group of segments 168 and second group of segments 169 is a transition point 170 to allow for the cap engagement 136 to smoothly ride between the first group 168 and second group 169.

As can be seen in FIG. 9, in the embodiment shown, there are three segments of first group 168 and three segments of the second group 169. The number of segments 166 corresponds, in this embodiment, to the number of clamps. Because there are three clamps utilized in this embodiment, there are three segments of the first group 168 and three segments of the second group 169.

When the locking cap 114 is operably mounted onto the filter base 22, each ball 138 rides in the continuous track 164. When each ball 138 is in the second group 169 of segments 166, each clamp member 125 is moved radially away from the filter base 22 and the bowl 26. When each ball 138 is in the first group 168 of segments 166, each clamp member 125 is in secured engagement with the bowl 26 and filter base 22. As each ball 138 moves across the transition point 170, there is pivotal motion translated about each pivot point 150 causing pivoting in a radial motion either toward or away of the clamp member 125 with the bowl 26 and filter base 22. In other words, in the illustrated embodiment, when the ball 138 is within the first group 168, the catch 130 is engaged with the recess 132 in the filter base 22, and the catch 134 is engaged and secured to the lip 170 of the bowl 26. When the cap 114 is rotated, the continuous track 164 is moved relative to each ball 138. As each ball 138 moves through the transition point and from the first group 168 into the second group 169 of segments 166, the ball 138 moves translating motion through the shafts 140 and 148 to move the first hook 128 and second hook 129 out of engagement with the filter base 22 and bowl 26.

In FIGS. 4 and 6, it can be seen that the cap 114 is biased to keep the cap 114 in a locking position relative to the filter base 22 due to the use of a biasing member 172, illustrated herein as a torsion spring 173. A fastener 175 secures together, but allows for rotational movement between the locking caps 114 and the base 22. A stop 176 extends axially from the filter base side 156 of the cap 114. The stop 176 allows for the spring 173 to be biased between the cap 114 and the filter base 22.

In operation, fluid to be cleaned passes into the filter base 22 through the inlet port 34 and into the inlet channel 44. From there, it flows into the bowl-cartridge filter 24 by passing through the inlet arrangement 86. It then passes into the unfiltered fluid volume 53, through the filter media 48 and into the cleaned fluid volume 52. From there, it flows through the fluid flow outlet 84, into the outflow channel 42, and flows out of the filter base 22 through the outlet port 36. During filtering, the filter base 22 is secured to the bowl 26 by the clamp arrangement 112. In particular, each first hook 128 is secured within the recess 132 of the filter base 22, and each second hook 129 is engaged with the lip 70 on the bowl 26.

To service the filter assembly 20, the locking cap 114 is grasped by placing a hand on the flange grasping members 160, 161. The cap is rotated relative to the base 22 and against the spring 173. This rotation action can be performed by hand, only, and without the use of tools. As the cap 114 is rotated relative to the base, each cap engagement member 136 is moved radially. The radial motion translates into pivoting and radial motion of each respective clamp member 125. Specifically, as the cap 114 is rotated, each ball 138 slides from the first group 168 of segments, through a transition point 170, and into the second group 169 of segments 166. This movement of the ball 138 translates into a pivoting motion of the first shaft 140 through the second shaft 148, which moves each respective clamp member 125 radially outwardly from the filter base 22 and bowl 26. This releases each first hook 128 from the recess 132 in the base 22, and releases each second hook 129 from the lip 70. With the clamp arrangement 112 released, the bowl 126 can be removed from the filter base 22. In some embodiments, the cartridge filter 28 will stay secured to the filter base 22 due to the seals 50, 56. The jacket 72 may then be grasped by the person performing the servicing. Because the jacket is preferably an impermeable material, the jacket 72 should be relatively clean. The jacket is grasped and the cartridge filter 28 is removed from the filter base 22 by a pulling motion. The cartridge filter 28 is then disposed of.

A new, second cartridge filter 28 is then operably mounted in the bowl 26. The step of mounting the cartridge filter 28 into the bowl 26 can include a tight fit therebetween sufficient to result in a load-transferring fit between the cartridge 28 and the bowl 26. First, the locking cap 114 is moved relative to the base 22 in order to move each clamp member 125 in a radially outwardly direction and allow for mounting of the bowl-cartridge filter 24 relative to the base. The bowl-cartridge filter 24 with the new, second cartridge filter 28 is then operably mounted onto the filter base 22. The seal member 50 and the second seal member 56 is created between the bowl-cartridge filter 24 and the filter base 22. The locking cap then biases due to the spring 173 back into a locking engagement. This moves each clamp member 125 into hooked secured engagement between the filter base 22 and the bowl 26. The filter assembly 20 is then in position for useable filtration.

### EXAMPLE PRINCIPLES

A method of servicing a filter assembly is provided. The filter assembly can have a filter base, a bowl removably attached to the filter base, and a filter cartridge removably positioned within the bowl. Example methods include releasing, by hand without tools, a clamp arrangement from engagement with the filter base and the bowl; removing the bowl and cartridge filter from the filter base; providing a second cartridge filter within the bowl; mounting the bowl having the second cartridge filter on the filter base; and

engaging the clamp arrangement to operably secure the filter base and the bowl with the second cartridge filter.

The step of releasing a clamp arrangement can include rotating a locking cap relative to the filter base in a first direction. The step of engaging the clamp arrangement can include rotating the locking cap relative to the filter base in a second direction. The clamp arrangement can include a hook arrangement to selectively engage the filter base and bowl. The step of releasing a clamp arrangement can include rotating a locking cap relative to the filter base to pivot the hook arrangement radially outwardly away from the filter base and bowl.

The clamp arrangement can include a plurality of discrete clamps; each of the clamps having a clamp member with a first hook and a second hook. The step of rotating a locking cap relative to the filter base to pivot the hook arrangement radially outwardly away can include pivoting each first hook and second hook of each respective clamp member radially outwardly from the filter base and bowl. The step of pivoting each first hook and second hook of each respective clamp member radially outwardly from the filter base and bowl can include pivoting each first hook from engagement with the filter base and pivoting each second hook from engagement with the bowl.

The clamp arrangement can include a plurality of discrete clamps; each of the clamps can include: a cap-engagement member; a shaft in extension from the cap-engagement member; a clamp member in extension from the shaft; the clamp member having first and second hooks; and a first hook in extension from the shaft. The step of releasing a clamp arrangement can include rotating the locking cap to move the cap-engagement member of each respective clamp, move each respective shaft, move the first hook of each clamp member away from the filter base, and move the second hook of each clamp member away from the bowl.

The locking cap can include a continuous track; the track having a plurality of segments; a first group of the segments being spaced a first distance from a centerpoint of the locking cap; and a second group of the segments being spaced a second distance from the centerpoint of the locking cap; the first distance being greater than the second distance; the cap-engagement member of each respective clamp being movable within the track. The step of releasing the clamp arrangement can include rotating the locking cap to slide each cap-engagement member within the groove from one of the segments in the first group into one of the segments in the second group and causing each clamp to pivot to move the first hook of each clamp member away from the filter base, and move the second hook of each clamp member away from the bowl.

The step of engaging the clamp arrangement to operably secure the filter base and the bowl with the second cartridge filter can include rotating the locking cap in the second direction to slide each cap-engagement member within the groove from one of the segments in the second group into one of the segments in the first group and cause each clamp to pivot to move the first hook of each clamp member into secured engagement with the filter base, and move the second hook of each clamp member into secured engagement with the bowl.

The filter cartridge can include an impermeable outer jacket defining a closed end, a filter-base engaging end, a sidewall therebetween, and an interior volume; the filter-base engaging end defining an inlet arrangement to allow for the passage of fluid into the cartridge filter, and an outlet arrangement to allow for the passage of fluid out of the cartridge filter; and a tubular region of filter media operably secured within the interior volume of the jacket to allow fluid to flow into an unfiltered fluid volume between the jacket and the filter media, through the filter media into a filtered fluid volume, and out of the cartridge filter from the filtered fluid volume through the outlet arrangement.

A filter assembly is provided and can include a filter base comprising a block defining an inlet arrangement and an outlet arrangement; a bowl removably attached to the filter base, a cartridge filter with filter media removably positioned within the bowl; the bowl and cartridge filter being operably mountable to the filter base to permit fluid to flow from the filter base inlet arrangement, into the cartridge, through the filter media, and out through the outlet arrangement in the filter base; and a locking cap to selectively engage the filter base; and a clamp arrangement; the clamp arrangement being operable to selectively secure and release the filter base together to the bowl by engagement between the locking cap and the filter base.

The clamp arrangement can include a plurality of discrete clamps; each of the clamps being pivotable radially into and out of engagement with the filter base and bowl. Each of the clamps can include: (i) a cap-engagement member; (ii) a first shaft in extension from the cap-engagement member; (iii) a clamp member in extension from the first shaft; the clamp member having first and second hooks; and (b) each of the clamps being pivotable to provide selective engagement between the first hook of each clamp member and the filter base and between the second hook of each clamp member and the bowl.

The locking cap can include a filter base side and a hand-manipulation side; the filter base side defining a continuous track; the track having a plurality of segments; a first group of the segments being spaced a first distance from a centerpoint of the locking cap; and a second group of the segments being spaced a second distance from the centerpoint of the locking cap; the first distance being greater than the second distance; the cap-engagement member of each respective clamp being movable within the track; the hand-manipulation side including flange grasping members to permit selective rotation of the locking cap relative to the filter base by a human hand; wherein rotating the locking cap into an unlocking direction relative to the filter base causes each cap-engagement member to slide within the groove from the first group of segments into the second group of segments and cause each of the first hooks to move out of engagement with the filter base, and cause each of the second hooks away from the bowl; and wherein rotating the locking cap into a locking direction relative to the filter base causes each cap-engagement member to slide within the groove from the second group of segments into the first group of segments and cause each of the first hooks to into engagement with the filter base, and cause each of the second hooks into engagement with the bowl.

The filter base can include a clamp mount for each respective clamp; each clamp including a second shaft pivotably secured to a respective clamp mount; each second shaft being in extension and generally perpendicular to a respective first shaft.

A system is provided and can include an engine utilizing fluid to operate; and a filter assembly as characterized above operably installed to clean the fluid utilized by the engine.

What is claimed is:

1. A method of servicing, without tools, a filter assembly; the filter assembly having a filter base, a bowl removably attached to the filter base, and a filter cartridge removably positioned within the bowl; the method comprising:
(a) releasing, by hand without tools, a clamp arrangement from engagement with the filter base and the bowl;
(b) removing the bowl and cartridge filter from the filter base;
(c) providing a second cartridge filter within the bowl;
(d) mounting the bowl having the second cartridge filter on the filter base; and
(e) engaging the clamp arrangement to operably secure the filter base and the bowl with the second cartridge filter.

2. A method according to claim 1 wherein:
(a) the step of releasing a clamp arrangement includes rotating a locking cap relative to the filter base in a first direction.

3. A method according to claim 2 wherein:
(a) the step of engaging the clamp arrangement includes rotating the locking cap relative to the filter base in a second direction.

4. A method according to claim 1 wherein:
(a) the clamp arrangement includes a hook arrangement to selectively engage the filter base and bowl; and
(b) the step of releasing a clamp arrangement includes rotating a locking cap relative to the filter base to pivot the hook arrangement radially outwardly away from the filter base and bowl.

5. A method according to claim 4 wherein:
(a) the clamp arrangement includes a plurality of discrete clamps; each of the clamps having a clamp member with a first hook and a second hook; and
(b) the step of rotating a locking cap relative to the filter base to pivot the hook arrangement radially outwardly away includes pivoting each first hook and second hook of each respective clamp member radially outwardly from the filter base and bowl.

6. A method according to claim 5 wherein:
(a) the step of pivoting each first hook and second hook of each respective clamp member radially outwardly from the filter base and bowl includes pivoting each first hook from engagement with the filter base and pivoting each second hook from engagement with the bowl.

7. A method according to claim 3 wherein:
(a) the clamp arrangement includes a plurality of discrete clamps; each of the clamps includes:
(i) a cap-engagement member;
(ii) a shaft in extension from the cap-engagement member;
(iii) a clamp member in extension from the shaft; the clamp member having first and second hooks; and a first hook in extension from the shaft; and
(b) the step of releasing a clamp arrangement includes rotating the locking cap to move the cap-engagement member of each respective clamp, move each respective shaft, move the first hook of each clamp member away from the filter base, and move the second hook of each clamp member away from the bowl.

8. A method according to claim 7 wherein:
(a) the locking cap includes a continuous track; the track having a plurality of segments;
(i) a first group of the segments being spaced a first distance from a centerpoint of the locking cap; and a second group of the segments being spaced a second distance from the centerpoint of the locking cap;
(A) the first distance being greater than the second distance;
(ii) the cap-engagement member of each respective clamp being movable within the track;
(b) the step of releasing the clamp arrangement includes rotating the locking cap to slide each cap-engagement member within the groove from one of the segments in the first group into one of the segments in the second group and causing each clamp to pivot to move the first hook of each clamp member away from the filter base, and move the second hook of each clamp member away from the bowl.

9. A method according to claim 8 wherein:
(a) the step of engaging the clamp arrangement to operably secure the filter base and the bowl with the second cartridge filter includes rotating the locking cap in the second direction to slide each cap-engagement member within the groove from one of the segments in the second group into one of the segments in the first group and causing each clamp to pivot to move the first hook of each clamp member into secured engagement with the filter base, and move the second hook of each clamp member into secured engagement with the bowl.

10. A method according to claim 1 wherein:
(a) the step of providing a second cartridge filter within the bowl includes mounting a tight fit therebetween sufficient to result in a load-transferring fit between the second filter cartridge and the bowl.

11. A filter assembly comprising:
(a) a filter base comprising a block defining an inlet arrangement and an outlet arrangement;
(b) a bowl removably attached to the filter base,
(c) a cartridge filter with filter media removably positioned within the bowl;
(i) the bowl and cartridge filter being operably mountable to the filter base to permit fluid to flow from the filter base inlet arrangement, into the cartridge, through the filter media, and out through the outlet arrangement in the filter base; and
(d) a locking cap to selectively engage the filter base; and
(e) a clamp arrangement; the clamp arrangement being operable to selectively secure and release the filter base together to the bowl by engagement between the locking cap and the filter base.

12. A filter assembly according to claim 1 1 wherein:
(a) the clamp arrangement includes a hook arrangement; the hook arrangement being movable into and out of engagement with the filter base and the bowl.

13. A filter assembly according to claim 12 wherein:
(a) the clamp arrangement includes a plurality of discrete clamps; each of the clamps being pivotable radially into and out of engagement with the filter base and bowl.

14. A filter assembly according to claim 13 wherein:
(a) each of the clamps includes:
(i) a cap-engagement member;
(ii) a first shaft in extension from the cap-engagement member;
(iii) a clamp member in extension from the first shaft; the clamp member having first and second hooks; and
(b) each of the clamps being pivotable to provide selective engagement between the first hook of each clamp member and the filter base and between the second hook of each clamp member and the bowl.

15. A filter assembly according to claim 14 wherein:
(a) the locking cap includes a filter base side and a hand-manipulation side; the filter base side defining a continuous track; the track having a plurality of segments;
(i) a first group of the segments being spaced a first distance from a centerpoint of the locking cap; and a second group of the segments being spaced a second distance from the centerpoint of the locking cap;
(A) the first distance being greater than the second distance;
(ii) the cap-engagement member of each respective clamp being movable within the track;
(iii) the hand-manipulation side including flange grasping members to permit selective rotation of the locking cap relative to the filter base by a human hand;
(A) wherein rotating the locking cap into an unlocking direction relative to the filter base causes each cap-engagement member to slide within the groove from the first group of segments into the second group of segments and cause each of the first hooks to move out of engagement with the filter base, and cause each of the second hooks away from the bowl; and
(B) wherein rotating the locking cap into a locking direction relative to the filter base causes each cap-engagement member to slide within the groove from the second group of segments into the first group of segments and cause each of the first hooks to into engagement with the filter base, and cause each of the second hooks into engagement with the bowl.

16. A filter assembly according to claim 14 wherein:
(a) the filter base includes a clamp mount for each respective clamp;
(i) each clamp including a second shaft pivotably secured to a respective clamp mount;
(ii) each second shaft being in extension and generally perpendicular to a respective first shaft.

17. A filter assembly according to claim 11 wherein:
(a) the cartridge filter includes an impermeable outer jacket defining a closed end, a filter-base engaging end, a sidewall therebetween, and an interior volume;
(i) the filter-base engaging end defining an inlet arrangement to allow for the passage of fluid into the cartridge filter, and an outlet arrangement to allow for the passage of fluid out of the cartridge filter; and
(b) a tubular region of filter media operably secured within the interior volume of the jacket to allow fluid to flow into an unfiltered fluid volume between the jacket and the filter media, through the filter media into a filtered fluid volume, and out of the cartridge filter from the filtered fluid volume through the outlet arrangement.

18. A filter assembly according to claim 17 wherein:
(a) the cartridge filter and the bowl have a load-transferring fit therebetween.

19. A filter assembly according to claim 18 wherein:
(a) the cartridge filter and the bowl have a clearance of not greater than 0.5 mm between an outer wall of the jacket and an inner wall of the bowl.

20. A fluid filtration system comprising:
(a) an engine utilizing fluid to operate; and
(b) a filter assembly operably installed to clean the fluid utilized by the engine; the filter assembly including:
(i) a filter base comprising a block defining an inlet arrangement and an outlet arrangement;
(ii) a bowl removably attached to the filter base,
(iii) a cartridge filter with filter media removably positioned within the bowl;
(A) the bowl and cartridge filter being operably mountable to the filter base to permit fluid to flow from the filter base inlet arrangement, into the cartridge, through the filter media, and out through the outlet arrangement in the filter base;
(iv) a locking cap to selectively engage the filter base; and
(v) a clamp arrangement; the clamp arrangement being operable to selectively secure and release the filter base together to the bowl by engagement between the locking cap and the filter base.

21. A cartridge filter and bowl arrangement comprising:
(a) a bowl including an interior volume; and
(b) a removable and replaceable cartridge filter operably positioned within the interior volume of the bowl; the cartridge filter including:
(i) an impermeable outer jacket defining a closed end, a filter-base engaging end, a sidewall therebetween, and an interior volume;
(A) the filter-base engaging end defining an inlet arrangement to allow for the passage of fluid into the cartridge filter, and an outlet arrangement to allow for the passage of fluid out of the cartridge filter; and
(ii) a tubular region of filter media operably secured within the interior volume of the jacket to allow fluid to flow into an unfiltered fluid volume between the jacket and the filter media, through the filter media into a filtered fluid volume, and out of the cartridge filter from the filtered fluid volume through the outlet arrangement;
(iii) wherein the cartridge filter and the bowl have a clearance between an inner wall of the bowl and an outer wall of the jacket of not greater than 0.5 mm.

22. A cartridge filter and bowl arrangement according to claim 21 wherein:
(a) the cartridge filter and the bowl have a clearance between an inner wall of the bowl and an outer wall of the jacket of not greater than 0.3 mm.

23. A cartridge filter comprising:
(a) an impermeable outer jacket defining a closed end, a filter-base engaging end, a sidewall therebetween, and an interior volume;
(i) the filter-base engaging end defining an inlet arrangement to allow for the passage of fluid into the cartridge filter, and an outlet arrangement to allow for the passage of fluid out of the cartridge filter; and
(b) a tubular region of filter media operably secured within the interior volume of the jacket.

24. A cartridge filter according to claim 23 wherein:
(a) the filter-base engaging end includes a baffle plate, and the inlet arrangement is defined by a plurality of slotted apertures in the baffle plate;
(i) the jacket and filter media being oriented to allow fluid to flow into an unfiltered fluid volume between the jacket and the filter media, through the filter media into a filtered fluid volume, and out of the cartridge filter from the filtered fluid volume through the outlet arrangement.

25. A cartridge filter according to claim 23 wherein:
(a) the impermeable outer jacket comprises a plastic material.
